(19) United States
(12) Patent Application Publication
(10) Pub. No.: US 2020/0080796 A1
(43) Pub. Date: Mar. 12, 2020

(54) ADDITIVE MANUFACTURED HEAT EXCHANGER

(71) Applicant: Siemens Aktiengesellschaft, Munich (DE)

(72) Inventors: Arindam Dasgupta, Avon, CT (US); Amit Chakraborty, East Windsor, NJ (US); Anand A. Kulkarni, Charlotte, NC (US)

(21) Appl. No.: 16/516,467

(22) Filed: Jul. 19, 2019

Related U.S. Application Data
(60) Provisional application No. 62/729,484, filed on Sep. 11, 2018.

(51) Int. Cl. F28F 7/02; F01D 5/18

(52) U.S. Cl. CPC F28F 7/02; F01D 5/188; F05D 2260/213; F05D 2220/32; F28F 2215/04

(57) ABSTRACT

3D printed thermal management devices and corresponding methods of manufacturing are described herein. A thermal management device includes a single contiguous component. The single contiguous component includes a body, a plurality of first fins extending away from the body and a plurality of second fins extending away from the body. A surface area of each first fin of the plurality of first fins is different than a surface area of each second fin of the plurality of second fins. A fin density of the plurality of first fins is different than a fin density of the plurality of second fins.

### PRIORITY

This application claims the benefit of U.S. Provisional Patent Application Ser. No. 62/729,484, filed on Sep. 11, 2018, which is hereby incorporated by reference in its entirety.

### BACKGROUND

Heat exchangers are key components in many energy and process systems. A main performance attribute of a heat exchanger is the efficient exchange of heat between different fluid streams in a smallest volume possible or over a smallest surface area possible. This, however, may be accomplished at the cost of pressure drop and/or weight. A large pressure drop is detrimental to overall process efficiency, as energy is spent to compensate for the pressure drop. Weight may be important for particular applications such as, for example, aerospace and transportation.

Heat transfer from primary heat exchange surfaces of a heat exchanger may be enhanced by secondary surfaces such as, for example, fins, as an amount of heat exchanged is directly proportional to a total surface area of the heat exchanger. The fins may be in a number of different forms and may have surface characteristics to promote turbulence or break-up boundary layers to promote heat transfer.

Pin fin heat exchangers, for example, may be made using conventional manufacturing processes such as, for example, die casting to form stamped plates with pin fins. A pin fin heat exchanger may be formed by pressure welding or brazing two of the stamped plates together. Each side of the pin fin heat exchanger includes pin fins having a same shape and being distributed at a same fin density.

### SUMMARY

In order to optimize heat transfer within a heat exchanger, fins with different shapes, fins arranged with different fin densities, and/or fins made of different material are additive manufactured on one or more surfaces of a body of the heat exchanger.

In a first aspect, a thermal management device includes a single contiguous component including a body, and a plurality of first fins extending away from the body and a plurality of second fins extending away from the body. Each first fin of the plurality of first fins has a first surface area, and each second fin of the plurality of second fins has a second surface area. The second surface area is different than the first surface area. A fin density of the plurality of first fins is different than a fin density of the plurality of second fins.

In one embodiment, the body has a first surface and a second surface opposite the first surface. The plurality of first fins and the plurality of second fins extend away from the first surface. The thermal management device further includes a plurality of third fins and a plurality of fourth fins extending away from the second surface. A surface area of each third fin of the plurality of third fins is different than a surface area of each fourth fin of the plurality of fourth fins. A fin density of the plurality of third fins is different than a fin density of the plurality of fourth fins.

In one embodiment, the body is a plate, and the first surface and the second surface of opposite sides of the plate, respectively. Alternatively, the body is cylindrical and hollow, and the first surface and the second surface are an inner surface and an outer surface of the cylindrical body, respectively.

In one embodiment, the thermal management device is a counter current or cross flow heat exchanger. The body is the cylindrical body. The cylindrical body is a tube through which a fluid is flowable.

In one embodiment, the body is a turbine blade. The plurality of first fins and the plurality of second fins extend away from an outer surface of the turbine blade, adjacent to a trailing edge of the turbine blade.

In one embodiment, the plurality of first fins are made of a different material than the plurality of second fins.

In one embodiment, the plurality of first fins are teardrop shaped, the plurality of second fins are teardrop shaped, or the plurality of first fins are teardrop shaped and the plurality of second fins are teardrop shaped.

In one embodiment, the plurality of first fins are a different shape than the plurality of second fins.

In one embodiment, first fins of the plurality of first fins that are adjacent in a first direction are further apart in the first direction than second fins of the plurality of second fins that are adjacent in the first direction, first fins of the plurality of first fins that are adjacent in a second direction are further apart in the second direction than second fins of the plurality of second fins that are adjacent in the second direction, or a combination thereof. The second direction is perpendicular to the first direction.

In one embodiment, the thermal management device further includes a plurality of third fins extending away from the body. The plurality of second fins are disposed between the plurality of first fins and the plurality of third fins, the plurality of third fins are adjacent to the plurality of first fins, the plurality of third fins are adjacent to the plurality of second fins, or any combination thereof.

In one embodiment, each third fin of the plurality of third fins has a third surface area. The third surface area is different than the second surface area and the first surface area.

In one embodiment, the plurality of third fins are a different shape than the plurality of first fins and the plurality of second fins.

In a second aspect, a heat exchanger includes a wall having a first surface and a second surface opposite the first surface. The heat exchanger also includes a plurality of first fins extending away from the first surface, and a plurality of second fins extending away from the second surface. The plurality of first fins are a different shape than the plurality of second fins, a fin density of the plurality of first fins is different than a fin density of the plurality of second fins, or a combination thereof.

In one embodiment, the wall is a cylindrical wall or a plate.

In one embodiment, the heat exchanger further includes a plurality of third fins extending away from the first surface and a plurality of fourth fins extending away from the second surface. The plurality of third fins are a different shape than the plurality of first fins, the fin density of the plurality of first fins is different than a fin density of the plurality of third fins, or a combination thereof. The plurality of fourth fins are a different shape than the plurality of second fins, the fin density of the plurality of second fins is different than a fin density of the plurality of fourth fins, or a combination thereof.

In one embodiment, each first fin of the plurality of first fins is a first teardrop shape, and each second fin of the plurality of second fins is a second teardrop shape.

In one embodiment, a first fin of the plurality of first fins is made of a different material than a second fin of the plurality of second fins.

In one embodiment, the heat exchanger is a counter current or cross flow heat exchanger.

In a third aspect, a method for manufacturing a thermal management device includes additive manufacturing a plurality of first fins and a plurality of second fins on a first surface of the thermal management device, such that a surface area of each first fin of the plurality of first fins is different than a surface area of each second fin of the plurality of second fins, a fin density of the plurality of first fins is different than a fin density of the plurality of second fins, or a combination thereof. The method also includes additive manufacturing a plurality of third fins and a plurality of fourth fins on a second surface of the thermal management device, such that a surface area of each third fin of the plurality of third fins is different than a surface area of each fourth fin of the plurality of fourth fins, a fin density of the plurality of third fins is different than a fin density of the plurality of fourth fins, or a combination thereof, the second surface being opposite the first surface.

In one embodiment, additive manufacturing the plurality of first fins and the plurality of second fins includes three-dimensionally (3D) printing the plurality of first fins and the plurality of second fins on the first surface of the thermal management device. Additive manufacturing the plurality of third fins and the plurality of fourth fins includes 3D printing the plurality of third fins and the plurality of fourth fins on the second surface of the thermal management device.

The present invention is defined by the following claims, and nothing in this section should be taken as a limitation on those claims. Any embodiments or aspects in one type of claim (e.g., method, system, or non-transitory computer readable media) may be provided in another type of claim. Further aspects and advantages of the invention are discussed below in conjunction with the preferred embodiments and may be later claimed independently or in combination.

### BRIEF DESCRIPTION OF THE DRAWINGS

For a more complete understanding of the disclosure, reference is made to the following detailed description and accompanying drawing figures, in which like reference numerals may be used to identify like elements in the figures.

FIG. 1 depicts one example of a heat exchanger.

FIG. 2 depicts a top view of one example of a plate of the heat exchanger of FIG. 1.

FIG. 3 depicts a bottom view of the plate of FIG. 2.

FIG. 4 depicts another example of a heat exchanger.

FIG. 5 depicts a side view of one example of a turbine blade.

FIG. 6 depicts a close-up view of fins adjacent to a trailing edge of the turbine blade of FIG. 5.

FIG. 7 is a flow diagram of a method of manufacturing a heat exchanger in accordance with one example.

While the disclosed devices, systems, and methods are representative of embodiments in various forms, specific embodiments are illustrated in the drawings (and are hereafter described), with the understanding that the disclosure is intended to be illustrative, and is not intended to limit the claim scope to the specific embodiments described and illustrated herein

### DETAILED DESCRIPTION

The present embodiments provide for heat exchanger surfaces that are adapted or designed based on a condition or a state of a fluid flow over the respective heat exchanger surface. For example, each fin of a heat exchanger surface may have a cross-section that is teardrop shaped and has an aspect ratio derived from an integrated optimization process between thermal management performance and additive manufacturing (AM) for a material used for forming the fins.

As the fluid passes through the heat exchanger in, for example, counter-current or cross-flow arrangement, as a temperature of the fluid changes, a Prandtl Number for the fluid changes and results in different heat transfer coefficients. This results in different total fin surface area being required to maintain a same product of heat transfer coefficient and area along a path of the fluid. To maintain the same produce of heat transfer coefficient and area along the path of the fluid, a fin shape (e.g., different aspect ratios for the teardrop shaped fins along the path of the fluid) and/or a fin density may be varied along the path of the fluid.

Prior art manufacturing processes for heat exchangers include, for example, stamping, extrusion, casting, and machining. Such manufacturing processes, however, are constrained based on the material being used and the device being manufactured. Heat exchangers manufactured with these prior art processes are also constrained by associated tolerances.

Fin density may be limited by these prior art manufacturing processes, and thus, a total surface area for heat transfer may also be limited. Tolerances for additive manufactured heat exchangers are smaller compared to the prior art manufacturing processes. Also, AM does not have the constraints discussed above. The additive manufactured heat exchangers may thus include fins having a higher fin density to take better advantage of previously wasted space and improve thermal performance of the heat exchanger. In other words, heat exchangers may be manufactured with AM, such that fins occupy 3D spaces not accessible by heat exchangers manufactured with prior art processes.

AM such as, for example, three-dimensional (3D) printing may be used to manufacture such a heat exchanger with variable fin shape and/or variable fin density along a path of a fluid. AM is an individual part manufacturing process, where each stage is separate and is continuously programmable as long as corresponding design data is provided. Each layer of the heat exchanger may thus be designed and deposited separately in the AM process. Accordingly, using AM, a heat exchanger having passages with geometries that vary along the length of the heat exchanger and also between different passages and channels of a same passage may be provided. A flexible design and manufacturing process that optimizes heat transfer and pressure drop within a heat exchanger is thus provided using AM and advanced optimization tools. This results in a heat exchanger with a high power density, as redundant surface area is minimized or eliminated.

As one application, AM of heat exchangers for gas turbines may provide a more efficient gas turbine (e.g., 0.7%-1.0% increase in efficiency), cost-effective generator and steam turbine components (e.g., 10-20% cost reduction), and faster design-manufacturing iterations (e.g., reducing lead-time up to 50% from a current baseline), as AM processes work directly with a 3D model and produce near-net shapes.

Disclosed herein are apparatuses, systems, and methods for improved heat transfer within a heat exchanger. 3D printing a thermal management device allows for optimized and customizable thermal solutions. For example, tight bends and non-planar geometries that may not be possible with traditional manufacturing methods may be manufactured using 3D printing. Plates of the heat exchanger, over which one or more fluids flow, and/or tubes of the heat exchanger, through which and over which fluids flow, respectively, (e.g., bodies of the heat exchanger) may include fins on one or more surfaces to increase a total surface area for heat transfer. The bodies, for example, and the fins of the heat exchanger may be printed as a single part, thus eliminating the use of a thermally inefficient bond to attach the fins to the bodies, reducing the weight of the thermal management system, and improving heat transfer within the heat exchanger compared to the prior art.

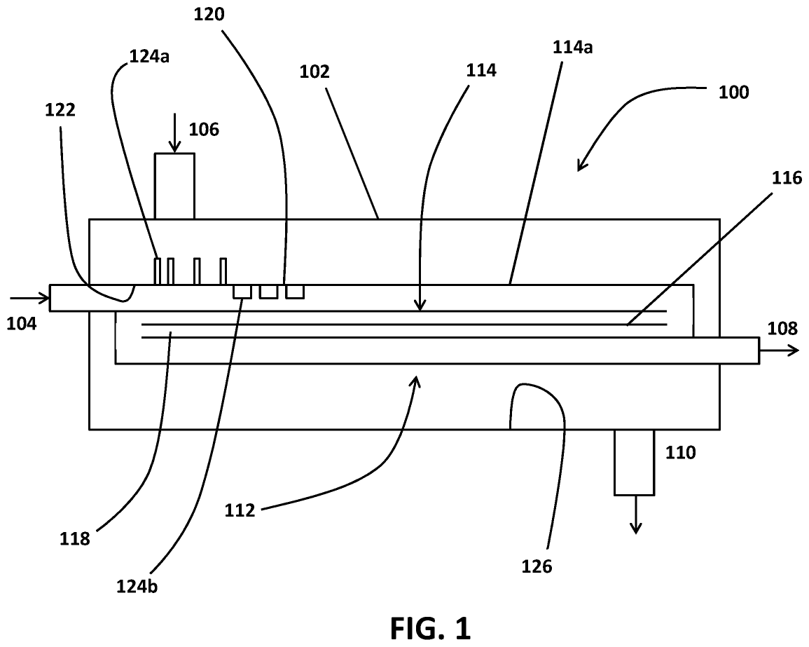

FIG. 1 shows one example of a heat exchanger 100. The heat exchanger 100 is a cross-flow heat exchanger (e.g., a plate and shell heat exchanger) but other types of heat exchangers may be provided. For example, a countercurrent flow heat exchanger or a concurrent flow heat exchanger may be provided. More specifically, a shell and tube heat exchanger, a plate heat exchanger, an adiabatic wheel heat exchanger, a plate fin heat exchanger, a pillow plate heat exchanger, a fluid heat exchanger, a waste heat recovery unit, a dynamic scraped surface heat exchanger, a phase-change heat exchanger, a direct contact heat exchanger, a microchannel heat exchanger, or another type of heat exchanger may be provided.

The heat exchanger 100 may be used in any number of applications. For example, the heat exchanger 100 may be used within power stations, refrigeration, air conditioning, space heating, chemical plants, petrochemical plants, petroleum refineries, natural-gas processing, sewage treatment, automobiles (e.g., within a radiator), and/or within other applications where heat is to be exchanged between fluids.

The heat exchanger 100 includes a housing 102 (e.g., a shell) and transfers heat between at least two fluids. The heat exchanger 100 includes a first inlet 104 and a second inlet 106, and a first outlet 108 and a second outlet 110. A hot first fluid flows through the first inlet 104 and is cooled down by a cold second fluid flowing through the second inlet 106. The cooled down first fluid flows out of the first outlet 108, and the warmed up second fluid flows out of the second outlet 110.

The first inlet 104 and the first outlet 108 also act as an input and an output, respectively, for a plate heat exchanger 112 that is disposed within the housing 102. The first fluid flows through the plate heat exchanger 112 via the first inlet 104 and the first outlet 108, and the second fluid flows over outer surfaces of the plate heat exchanger 112, from the second inlet 106 to the second outlet 110. Heat is transferred between the first fluid and the second fluid via conduction through one or more walls separating the first fluid and the second fluid and via convection from the first fluid flowing through the plate heat exchanger 112 to the second fluid flowing over the plate heat exchanger 112. Heat may also be transferred out of the heat exchanger 100 via radiation.

The at least two fluids may be a same fluid or two or more different fluids. For example, the heat exchanger 100 transfers heat between a first fluid and a second fluid. In one embodiment, the first fluid is water, and the second fluid is water. In another embodiment, the first fluid is water, and the second fluid is air. In yet another embodiment, the first fluid is air, and the second fluid is a liquid coolant. Other combinations of fluids may be provided.

The plate heat exchanger 112 includes a plurality of plates 114 (e.g., four plates 114 in FIG. 1) stacked on top of each other that define a number of passes (e.g., three passes) through the plate heat exchanger 112. In one embodiment, the heat exchanger 100 is a shell and tube heat exchanger, and a series of tubes is disposed within the housing 102 instead of the plurality of plates 114. One or more of the passes may include a baffle 116 to form a number of channels 118 within the respective pass and increase the surface area for heat transfer.

For optimal efficiency of the heat exchanger 100, a surface area of the one or more walls separating the first fluid and the second fluid may be maximized and a resistance to fluid flow (e.g., of the first fluid and the second fluid) may be minimized. The surface area of the one or more walls separating the first fluid and the second fluid may be increased with the addition of fins. The fins and/or corrugations may be added to the one or more walls or other parts of the heat exchanger to also channel fluid flow and/or to induce turbulence. Depending on fin shape, size and density, however, the fins may also resist the fluid flow.

For example, a first surface 120 (e.g., an outer surface of the housing 102) and a second surface 122, which is opposite the first surface 120, of at least a first plate 114a of the plurality of plates 114 include fins 124. Other plates of the plurality of plates 114 and/or other surfaces within the heat exchanger 100 may include fins. For example, one or more inner surfaces 126 of the housing 102 may include fins.

Using, for example, engineering design optimization tools (e.g., ANSYS, NX with an optimization package), a number of fins, a shape of fins, a size of fins, one or more fin materials, and/or fin density for fins on and within the heat exchanger 100, for example, may be determined, such that a pressure drop of the first fluid and/or the second fluid is matched or minimized and heat transfer between the first fluid and the second fluid is maximized. AM such as, for example, 3D printing allows fins of variable shape, size, material, and/or density to be printed directly onto a body of the heat exchanger 100, for example. A body of the heat exchanger 100 may be, for example, a plate of the plurality of plates 114, the housing 102, or another part of the heat exchanger 100.

In one embodiment, at least some (e.g., all) parts of the heat exchanger 100 are 3D printed. For example, each plate of the plurality of plates 114 is 3D printed, and fins 124 are 3D printed directly onto the respective plate 114 such that the respective plate 114 and the respective fins 124 form a contiguous component. For example, the fins 124 may be 3D printed directly on the first surface 120 and the second surface 122 of the first plate 114a, respectively. The first plate 114a, the fins 124 extending away from the first surface 120 of the first plate 114a, and the fins 124 extending away from the second surface 122 of the first plate 114a form a single contiguous 3D printed part. Such a contiguous component does not require a thermal interface material (e.g., a thermal glue) or other connectors to attach the fins to the respective plate 114. This results is a lower thermal resistance and thus improved thermal performance compared to prior art devices that require such thermal interface materials and/or other connectors.

The optimization discussed above may result in different plates of the plurality of plates 114 having different numbers of fins, different shapes of fins, different sizes of fins, different fin materials, and/or different fin densities extending away from one or both surfaces of the respective plate. Surfaces (e.g., the second surface 122 of the first plate 114a) of the heat exchanger 100 are adaptable to the condition and state of the fluid (e.g., the first fluid) as the fluid flows over the respective surface.

For example, the optimization takes temperature change of the first fluid, for example, into account (e.g., along a single pass of the plate heat exchanger 112 or along all passes of the plate heat exchanger 112) when determining the number of fins, the shape of the fins, the size of the fins, the material of the fins, and/or the fin density for the fins on and within the heat exchanger 100. The Prandtl Number changes as the temperature of the first fluid changes (e.g., decreases), which results in different heat transfer coefficients. Total fin area may vary in a direction of the flow of the first fluid, such that a product of heat transfer coefficient and area may be maintained along the direction of the flow. Each layer of the heat exchanger 100 (e.g., each plate of the plurality of plates 114 of the plate heat exchanger 112) may be designed (e.g., optimized) and manufactured (e.g., 3D printed) separately.

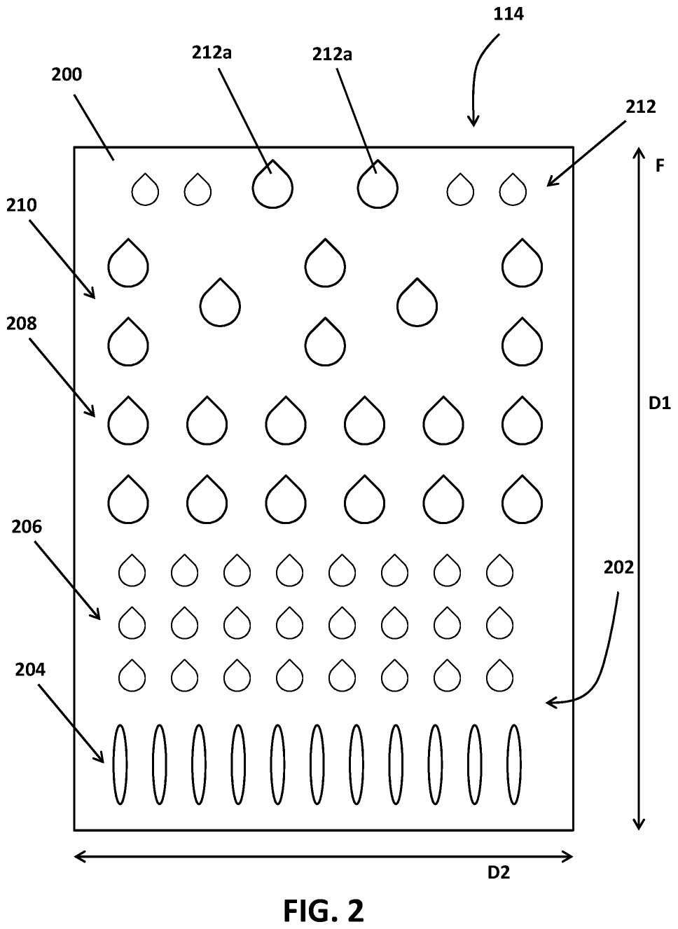

FIG. 2 shows a top view of one example of an additive manufactured (e.g., 3D printed) plate 114 of the heat exchanger 100 of FIG. 1. As shown in FIG. 2, fin shape, fin size, and/or fin density may vary in a longitudinal direction D1 of the plate 114 (e.g., along a flow direction F) and/or in a lateral direction D2 of the plate (e.g., perpendicular to the flow direction F).

FIG. 2 shows a first surface 200 of a plate 114 from FIG. 1. A plurality of fins 202 extend away from the first surface 200. Each fin of the plurality of fins 202 may extend away from the first surface 200 in a same direction, or at least some fins 202 of the plurality of fins 202 may extend away from the first surface 200 in different direction. In the example shown in FIG. 2, each fin of the plurality of fins 202 extends away from the first surface 200 in a direction perpendicular to the first surface 200.

The plurality of fins 202 include a plurality of first fins 204, a plurality of second fins 206, a plurality of third fins 208, a plurality of fourth fins 210, and plurality of fifth fins 212. The plurality of first fins 204 are oval shaped. The example shown in FIG. 2 includes eleven first fins 204 positioned in a single row, but more or fewer first fins 204 may be provided in one or more rows. The plurality of second fins 206 are teardrop shaped. A teardrop shaped fin may maximize surface area over which the fluid (e.g., the first fluid) flows and may be a good shape for fluid dynamics purposes (e.g., to reduce resistance to flow). The example shown in FIG. 2 includes 24 second fins 206 positioned in three rows, eight second fins 206 per row, but more or fewer second fins 206 may be provided in more or fewer rows. The plurality of third fins 208 are teardrop shaped, but are larger than the teardrop shaped second fins 206. The example shown in FIG. 2 includes twelve third fins 208 positioned in two rows, six third fins 208 per row, but more or fewer third fins 208 may be provided in more or fewer rows. The plurality of fourth fins 210 are teardrop shaped and are the same size as the teardrop shaped third fins 208. The plurality of fourth fins 210, however, have a lower fin density per unit area than the plurality of third fins 208. The example shown in FIG. 2 includes eight fourth fins 210 positioned in three rows, three fourth fins 210 in two of the rows and two fourth fins 210 in one of the rows. More or fewer fourth fins 210 may be provided in more or fewer rows. The plurality of fifth fins 212 are teardrop shaped and include fins that are the same size as the second fins 206 and fins that are the same size as the third fins 208 and the fourth fins 210. The example shown in FIG. 2 includes six fifth fins 212 in a single row, but more or fewer fifth fins 212 may be provided in one or more rows.

As shown in the example of FIG. 2, the size and/or shape of fins of the plurality of fins 202 may vary along both the longitudinal direction D1 and the lateral direction D2. For example, the shape of the plurality of fins 202 varies between the plurality of first fins 204 (e.g., oval-shaped) and the plurality of second fins 206 (e.g., teardrop shaped) along the longitudinal direction D1, and the size of the plurality of fins varies 202 between fins of the plurality of fifth fins 212. First and second fifth fins 212a, which are centered within the plurality of fifth fins 212, are larger than the other fins of th plurality of fifth fins 212. Fin size and/or shape may vary along different directions other than the longitudinal direction D1 and the lateral direction D1. For example, fin size and/or fin shape may vary along a direction between the longitudinal direction D1 and the lateral direction D2 (e.g., in a direction diagonal to the longitudinal direction D1 and the lateral direction D2).

The size and/or shape of the plurality of fins 202 may be varied based on an optimization maximizing heat transfer and/or minimizing pressure drop. For example, fin size and/or shape increases along the flow direction F (e.g., between the plurality of second fins 206 and the plurality of third fins 208), such that heat transfer may remain constant as the temperature of the flow of, for example, the first fluid increases long the flow direction F. The fin size and/or fin shape may be varied, such that a corresponding surface area for heat transfer is also varied. For example, each fin of the plurality of first fins 204 has a different surface area than each fin of the plurality of second fins 206 and each fin of the plurality of third fins 208, and each fin of the plurality of second fins 206 has a different surface area than each fin of the plurality of third fins 208.

Further, the fin density of the plurality of fins 202 may vary along the longitudinal direction D1, the lateral direction D2, or any number of other directions. For example, as shown in FIG. 2, the fin density decreases along the longitudinal direction D1 between the plurality of second fins 206 and the plurality of third fins 208, and decreases and increases in the lateral direction D2 within the plurality of fifth fins 212.

In one embodiment, some fins of the plurality of fins 202 are made of different materials. AM such as, for example, 3D printing may allow for different components of a thermal management device such as, for example, a plate heat exchanger to be formed with multiple materials as a single contiguous component. Fin material, and corresponding thermal conductivity, may be a variable to be solved for as part of an optimization.

The plate 114 and/or the plurality of fins 202 may be made of any number of materials including, for example, plastics, composites, graphite, copper, titanium, aluminum, titanium, or other thermally conductive materials. In one example, different composites and/or materials with increasing thermal conductivity are used for the plurality of fins 202 along, for example, the flow direction F.

For example, the plurality of second fins 206 are 3D printed with a first material (e.g., a first composite with a first thermal conductivity), and the plurality of third fins 208 are 3D printed with a second, different material (e.g., a second composite with a second thermal conductivity greater than the first thermal conductivity). The plate 114 may be made of the first material, the second material, or a third material different than the first material and the second material. Other fins of the plurality of fins 202 extending away from the first surface 200 may be made of the first material, the second material, or the third material. In one embodiment, different fins within a particular grouping of fins defined by size, shape, and/or fin density (e.g., the plurality of first fins 204) may be made of different materials.

The configuration of the plurality of fins 202 in FIG. 2 (e.g., shape, size, density) is exemplary, and any number of different configurations of fins may be provided based on a particular optimization. Other shapes such as, for example, circular fins may be provided. Further, more or fewer different types of fins, different fin orientations and spacing, and/or different fin materials may be provided. Other configurations may include more irregular positioning of the fins.

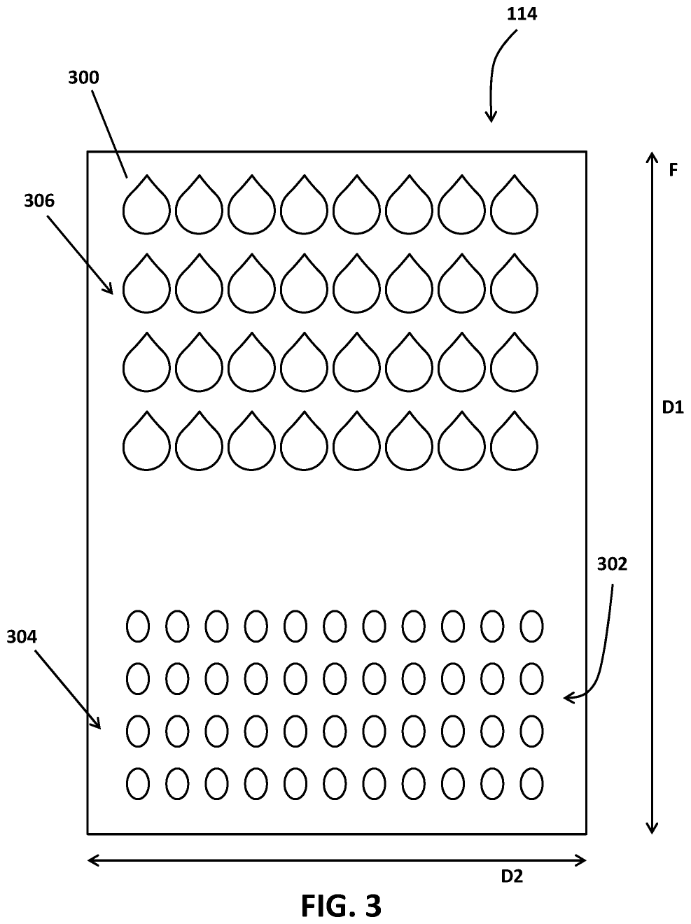

FIG. 3 shows a bottom view of the additive manufactured plate 114 of FIG. 2 (e.g., an opposite surface). As shown in FIG. 3, fin shape, fin size, and/or fin density may vary in the longitudinal direction D1 of the plate 114 and/or in the lateral direction D2 of the plate (e.g., perpendicular to the flow direction F).

FIG. 3 shows a second surface 300 of the plate 114 from FIG. 2. A plurality of fins 302 extend away from the second surface 300. Each fin of the plurality of fins 302 may extend away from the second surface 300 in a same direction, or at least some fins 302 of the plurality of fins 302 may extend away from the second surface 300 in different directions. In the example shown in FIG. 3, each fin of the plurality of fins 302 extends away from the second surface 300 in a direction perpendicular to the second surface 300.

The use of AM (e.g., 3D printing) to produce the plate 114 shown in FIGS. 2 and 3 allows different fin shapes, fin sizes, and/or fin densities to be provided at each of the first surface 200 and the second surface 300 and across the first surface 200 and the second surface 300. For example, the plurality of fins 302 include a plurality of first fins 304 and a plurality of second fins 306. The plurality of first fins 304 are oval shaped but a different oval shape than the plurality of first fins 204 at the first surface 200, and are a different size and have a different fin density than any fins of the plurality of fins 202 at the first surface 200. The example shown in FIG. 3 includes thirty three first fins 304 positioned in three rows, but more or fewer first fins 304 may be provided in more or fewer rows. The plurality of second fins 306 are teardrop shaped but are larger and have a greater fin density than any fins of the plurality of fins 202 at the first surface 200.

As shown in FIG. 3, the plurality of fins 302 may not cover the entire second surface 300. For example, the plurality of second fins 306 may be spaced apart from the plurality of first fins 304. Such spacing may be for fluid dynamics and/or pressure drop purposes.

The configuration of the plurality of fins 302 in FIG. 3 (e.g., shape, size, density) is exemplary, and any number of different configurations of fins may be provided based on a particular optimization. Other shapes such as, for example, circular fins may be provided. Further, more or fewer different types of fins, different fin orientations and spacing, and/or different fin materials may be provided. Other configurations may include more irregular positioning of the fins.

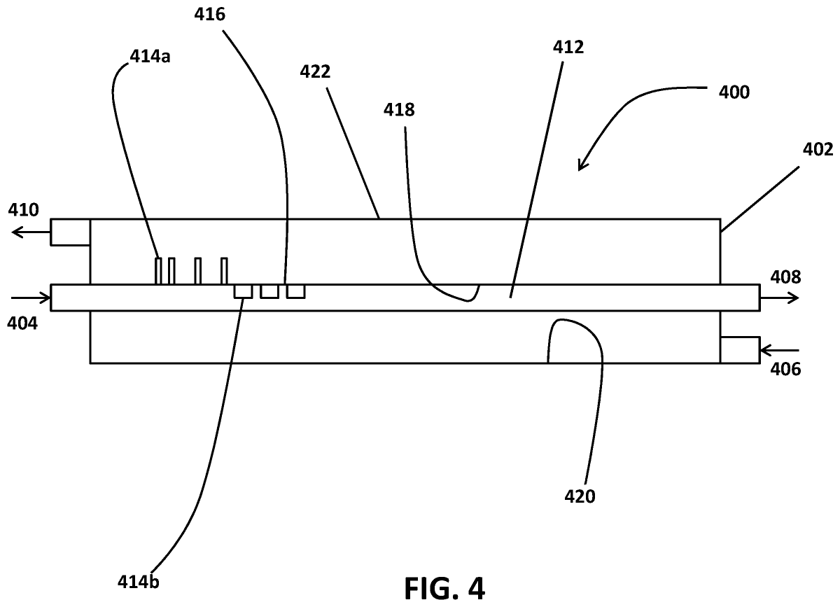

FIG. 4 shows another example of a heat exchanger 400 for which additive manufactured (e.g., 3D-printed) fins 402 with varied size, shape, fin density, and/or fin material may be applied. The heat exchanger 400 is, for example, a countercurrent flow heat exchanger (e.g., a shell and tube heat exchanger), but other types of heat exchangers may be provided.

The heat exchanger 400 may be used in any number of applications. For example, the heat exchanger 400 may be used within power stations, refrigeration, air conditioning, space heating, chemical plants, petrochemical plants, petroleum refineries, natural-gas processing, sewage treatment, automobiles (e.g., within a radiator), and/or within other applications where heat is to be exchanged between fluids.

The heat exchanger 400 includes a housing 402 (e.g., a shell) and transfers heat between at least two fluids. The heat exchanger 400 includes a first inlet 404 and a second inlet 406, and a first outlet 408 and a second outlet 410. A hot first fluid flows through the first inlet 404 and is cooled down by a cold second fluid flowing through the second inlet 406. The cooled down first fluid flows out of the first outlet 408, and the warmed up second fluid flows out of the second outlet 410.

The first inlet 404 and the first outlet 408 also act as an input and an output, respectively, for a tube 412 that is disposed within the housing 402. In one embodiment, the tube 412 is one of a plurality of connected tubes defined in multiple passes. The first fluid flows through the tube 412 via the first inlet 404 and the first outlet 408, and the second fluid flows over an outer surface of the tube 412, from the second inlet 406 to the second outlet 410. Heat is transferred between the first fluid and the second fluid via conduction through one or more walls separating the first fluid and the second fluid and via convection from the first fluid flowing through the tube 412 to the second fluid flowing over the tube 412. Heat may also be transferred out of the heat exchanger 400 via radiation.

The at least two fluids may be a same fluid or two or more different fluids. For example, the heat exchanger 400 transfers heat between a first fluid and a second fluid. In one embodiment, the first fluid is water, and the second fluid is water. In another embodiment, the first fluid is water, and the second fluid is air. In yet another embodiment, the first fluid is air, and the second fluid is a liquid coolant. Other combinations of fluids may be provided.

Any number of surfaces of the heat exchanger 400 may include fins extending away from the respective surface. Fin shape, fin size, and/or fin density may be optimized, as described above, and the fin shape, fin size, and/or fin density may be varied along any number of different surfaces of the heat exchanger 400. For example, as shown in FIG. 4, fins 414a may be 3D printed on an outer surface 416 of the tube 412, and/or fins 414b may be 3D printed on an inner surface 418 of the tube 412, such that the tube 412 and the fins 414a and/or the fins 414b form a single contiguous 3D printed component. In the embodiment in which the heat exchanger 400 includes a plurality of tubes 412 forming multiple passes, the fins 414b at the inner surface 418 of each tube 412 of the plurality may be configured differently (e.g., different fin size, fin shape, and/or fin density).

Fins may be 3D printed on other surfaces within and/or on the heat exchanger to form other single contiguous components. For example, fins may be 3D printed on one or more inner surfaces 420 and/or one or more outer surfaces 422 of the housing 402, such that fins and the housing 402 form a single contiguous 3D printed component. In one embodiment, the housing 402, the tube 412, and the fins 414 form a single contiguous 3D printed component.

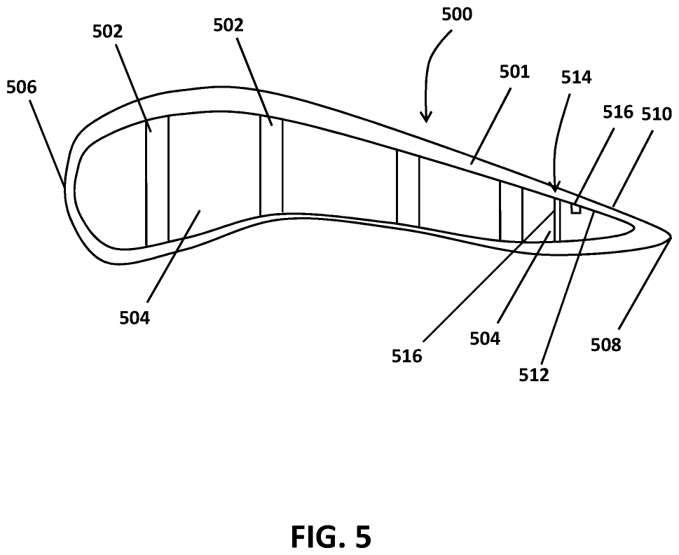

AM (e.g., 3D printed) may be used to form fins on and/or within any number of different parts within any number of different industries. For example, FIG. 5 shows an example of a blade 500 for a gas turbine for a power plant. In another embodiment, the blade is for a different type of turbine such as, for example, a wind turbine or a jet engine. The blade 500 may be 3D printed, for example, using any number of different materials including, for example, a nickel based superalloy including titanium and/or aluminum. The blade 500 may be made of other materials.

The blade 500 includes a housing 501 and a plurality of supports 502 within the housing 501. The plurality of supports 502 form a plurality of channels 504 through which a cooling fluid (e.g., air) may flow. The blade has a leading edge 506 and a trailing edge 508. The blade 500 has one or more outer surfaces 510 and one or more inner surfaces 512. The blade 500 includes a thermal management device 514 that includes a plurality of fins 516 extending away from at least one of the one or more inner surfaces 512. For example, the plurality of fins 516 extend away from the at least one inner surface 512 at and/or adjacent to the trailing edge 508 of the blade 500 (e.g., within a distance less than 20% of a distance between the leading edge 506 and the trailing edge 508). A size, shape, and/or fin density of fins of the plurality of fins 516 may be determined based on an optimization, as discussed above. In one embodiment, at least some fins of the plurality of fins 516 extend across at least one channel of the plurality of channels 504. Other surfaces on and/or within the blade and other parts of the turbine may include fins 3D printed directly on the respective part.

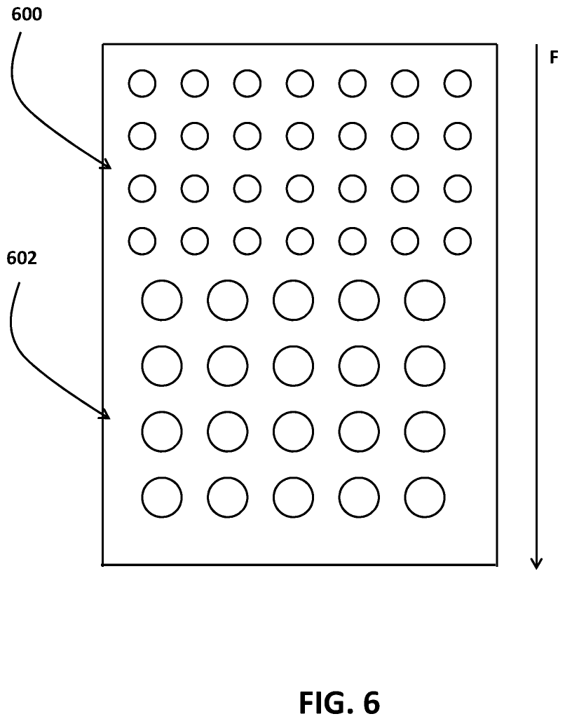

FIG. 6 shows a close-up view of the plurality of fins 516 adjacent to the trailing edge 508 of the blade 500 of FIG. 5. Along a flow direction F, the plurality of fins 516 vary in size and fin density with a first group of fins 600 and a second group of fins 602. Each fin of the first group of fins 600 and the second group of fins 602 is a pin fin (e.g., cylindrical in shape). Fins of the second group of fins 602 are larger than fins of the first group of fins 600, but the fins in the first group of fins 600 have a higher fin density than the fins of the second group of fins 602. In other embodiments, other configurations of the plurality of fins 516 are provided.

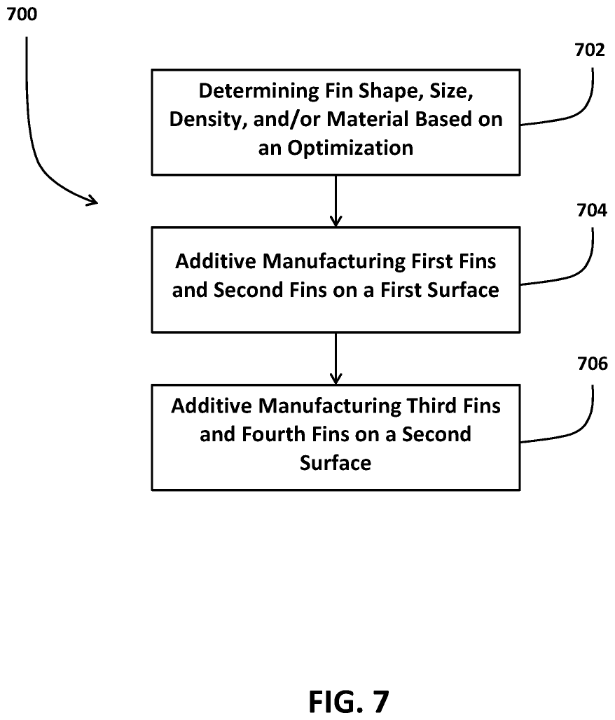

FIG. 7 shows a flowchart of one example of a method 700 for manufacturing a heat exchanger. The method 700 is implemented in the order shown, but other orders may be used. Additional, different, or fewer acts may be provided. Similar methods may be used for manufacturing a heat exchanger.

In act 702, a processor determines a fin shape, fin size, fin material, and/or fin density for different groups of fins of the heat exchanger based on an optimization. The different fins of the heat exchanger may extend from different surfaces of the heat exchanger. For example, the different surfaces of the heat exchanger may be surfaces within different passes of a heat exchanger (e.g., a shell and plate heat exchanger or a shell and tube heat exchanger).

In one embodiment, the processor generates a model of the heat exchanger and determines the fin shape, fin size, fin material, and/or fin density for the different groups of fins using the generated model of the heat exchanger and advanced optimization tools. The processor may determine the fin shape, fin size, fin material, and/or fin density for the different groups of fins, such that, for example, heat transfer is maximized and/or pressure drop is minimized within the heat exchanger.

In act 704, a plurality of first fins and a plurality of second fins are additive manufactured (e.g., 3D printed) on a first surface of the heat exchanger based on the fin shape, fin size, fin density, and/or fin material determined act 702. In one embodiment, the plurality of first fins and the plurality of second fins are 3D printed, for example, on the first surface of the heat exchanger, such that a surface area of each first fin of the plurality of first fins is different than a surface area of each second fin of the plurality of second fins (e.g., different size and/or shape), a fin density of the plurality of first fins is different than a fin density of the plurality of second fins, a fin material of the plurality of first fins is different than a fin material of the plurality of second fins, or any combination thereof

The 3D printing may include depositing layers of material onto a power bed with inkjet printer heads. Alternatively or additionally, the 3D printing may include an extrusion-based process, a sintering-based process, or another process. In an extrusion-based process, small beads of material are extruded, and the small beads of material harden to form the layers. In a sintering-based process, heat and/or pressure is used to compact and/or form the layers. The successive layers of material may be deposited under computer control based on a 3D model to produce an object (e.g., a turbine blade).

The plurality of first fins and the plurality of second fins may be 3D printed directly on the first surface, which, for example, is a first surface of a plate or a tube (e.g., a body) of a shell and plate heat exchanger or a shell and tube heat exchanger, respectively. The plurality of first fins and the plurality of second fins may be 3D printed on any number of different bodies of heat exchangers to form a single contiguous component. For example, the plurality of first fins and the plurality of second fins may be 3D printed on a surface of the shell (e.g., a housing) of the heat exchanger.

The plurality of first fins and the plurality of second fins may be 3D printed using any number of different materials. For example, the plurality of first fins and the plurality of second fins may be 3D printed using copper, aluminum, titanium, gold, a composite, an metal alloy, another thermally conducting material, or any combination thereof. As one example, the plurality of first fins and the plurality of second fins may be 3D printed using two different materials (e.g., copper and aluminum; different composites).

In act 706, a plurality of third fins and a plurality of fourth fins are additive manufactured (e.g., 3D printing) on a second surface of the heat exchanger based on the fin shape, fin size, fin density, and/or fin material determined in 702. The second surface is, for example, opposite the first surface. In one embodiment, the first surface is an outer surface of a tube, and the second surface is an inner surface of the tube. In another embodiment, the first surface is an outer surface of a turbine blade, and the second surface is an inner surface of the turbine blade.

In one embodiment, the plurality of third fins and the plurality of fourth fins are 3D printed, for example, on the second surface of the heat exchanger, such that a surface area of each third fin of the plurality of third fins is different than a surface area of each fourth fin of the plurality of fourth fins (e.g., different size and/or shape), a fin density of the plurality of third fins is different than a fin density of the plurality of fourth fins, a fin material of the plurality of third fins is different than a fin material of the plurality of fourth fins, or any combination thereof

The 3D printing may include depositing layers of material onto a power bed with inkjet printer heads. Alternatively or additionally, the 3D printing may include an extrusion-based process, a sintering-based process, or another process. In an extrusion-based process, small beads of material are extruded, and the small beads of material harden to form the layers. In a sintering-based process, heat and/or pressure is used to compact and/or form the layers. The successive layers of material may be deposited under computer control based on a 3D model to produce an object (e.g., the turbine blade).

The plurality of third fins and the plurality of fourth fins may be 3D printed directly on the second surface, which, for example, is a second surface of the plate or the tube (e.g., the body) of the shell and plate heat exchanger or the shell and tube heat exchanger, respectively. The plurality of third fins and the plurality of fourth fins may be 3D printed on any number of different bodies of heat exchangers to form a single contiguous component. For example, the plurality of third fins and the plurality of fourth fins may be 3D printed on a surface of the shell (e.g., a housing) of the heat exchanger.

The plurality of third fins and the plurality of fourth fins may be 3D printed using any number of different materials. For example, the plurality of third fins and the plurality of fourth fins may be 3D printed using copper, aluminum, titanium, gold, a composite, an metal alloy, another thermally conducting material, or any combination thereof. As one example, the plurality of third fins and the plurality of fourth fins may be 3D printed using two different materials (e.g., copper and aluminum; different composites).

While the present claim scope has been described with reference to specific examples, which are intended to be illustrative only and not to be limiting of the claim scope, it will be apparent to those of ordinary skill in the art that changes, additions and/or deletions may be made to the disclosed embodiments without departing from the spirit and scope of the claims.

The foregoing description is given for clearness of understanding only, and no unnecessary limitations should be understood therefrom, as modifications within the scope of the claims may be apparent to those having ordinary skill in the art.

1. A thermal management device comprising:
a single contiguous component comprising:
a body; and
a plurality of first fins extending away from the body and a plurality of second fins extending away from the body, each first fin of the plurality of first fins having a first surface area and each second fin of the plurality of second fins having a second surface area, the second surface area being different than the first surface area,
wherein a fin density of the plurality of first fins is different than a fin density of the plurality of second fins.

2. The thermal management device of claim 1, wherein the body has a first surface and a second surface opposite the first surface, the plurality of first fins and the plurality of second fins extending away from the first surface,
wherein the thermal management device further comprises a plurality of third fins and a plurality of fourth fins extending away from the second surface, a surface area of each third fin of the plurality of third fins being different than a surface area of each fourth fin of the plurality of fourth fins, and
wherein a fin density of the plurality of third fins is different than a fin density of the plurality of fourth fins.

3. The thermal management device of claim 2, wherein the body is a plate, and the first surface and the second surface of opposite sides of the plate, respectively, or
wherein the body is cylindrical and hollow, and the first surface and the second surface are an inner surface and an outer surface of the cylindrical body, respectively.

4. The thermal management device of claim 3, wherein the thermal management device is a counter current or cross flow heat exchanger, and
wherein the body is the cylindrical body, the cylindrical body being a tube through which a fluid is flowable.

5. The thermal management device of claim 3, wherein the body is a turbine blade, and
wherein the plurality of first fins and the plurality of second fins extend away from an inner surface of the turbine blade, adjacent to a trailing edge of the turbine blade.

6. The thermal management device of claim 1, wherein the plurality of first fins are made of a different material than the plurality of second fins.

7. The thermal management device of claim 1, wherein the plurality of first fins are teardrop shaped, the plurality of second fins are teardrop shaped, or the plurality of first fins are teardrop shaped and the plurality of second fins are teardrop shaped.

8. The thermal management device of claim 7, wherein the plurality of first fins are a different shape than the plurality of second fins.

9. The thermal management device of claim 1, wherein first fins of the plurality of first fins that are adjacent in a first direction are further apart in the first direction than second fins of the plurality of second fins that are adjacent in the first direction, first fins of the plurality of first fins that are adjacent in a second direction are further apart in the second direction than second fins of the plurality of second fins that are adjacent in the second direction, or a combination thereof, the second direction being perpendicular to the first direction.

10. The thermal management device of claim 1, further comprising a plurality of third fins extending away from the body,
wherein the plurality of second fins are disposed between the plurality of first fins and the plurality of third fins, the plurality of third fins are adjacent to the plurality of first fins, the plurality of third fins are adjacent to the plurality of second fins, or any combination thereof.

11. The thermal management device of claim 10, wherein each third fin of the plurality of third fins has a third surface area, the third surface area being different than the second surface area and the first surface area.

12. The thermal management device of claim 11, wherein the plurality of third fins are a different shape than the plurality of first fins and the plurality of second fins.

13. A heat exchanger comprising:
a wall having a first surface and a second surface opposite the first surface;
a plurality of first fins extending away from the first surface; and
a plurality of second fins extending away from the second surface,
wherein the plurality of first fins are a different shape than the plurality of second fins, a fin density of the plurality of first fins is different than a fin density of the plurality of second fins, or a combination thereof.

14. The heat exchanger of claim 13, wherein the wall is a cylindrical wall or a plate.

15. The heat exchanger of claim 13, further comprising a plurality of third fins extending away from the first surface and a plurality of fourth fins extending away from the second surface,
wherein the plurality of third fins are a different shape than the plurality of first fins, the fin density of the plurality of first fins is different than a fin density of the plurality of third fins, or a combination thereof, and
the plurality of fourth fins are a different shape than the plurality of second fins, the fin density of the plurality of second fins is different than a fin density of the plurality of fourth fins, or a combination thereof.

16. The heat exchanger of claim 13, wherein each first fin of the plurality of first fins is a first teardrop shape, and each second fin of the plurality of second fins is a second teardrop shape.

17. The heat exchanger of claim 13, wherein a first fin of the plurality of first fins is made of a different material than a second fin of the plurality of second fins.

18. The heat exchanger of claim 13, wherein the heat exchanger is a counter current or cross flow heat exchanger.

19. A method for manufacturing a thermal management device, the method comprising:
additive manufacturing a plurality of first fins and a plurality of second fins on a first surface of the thermal management device, such that a surface area of each first fin of the plurality of first fins is different than a surface area of each second fin of the plurality of second fins, a fin density of the plurality of first fins is different than a fin density of the plurality of second fins, or a combination thereof; and
additive manufacturing a plurality of third fins and a plurality of fourth fins on a second surface of the thermal management device, such that a surface area of each third fin of the plurality of third fins is different than a surface area of each fourth fin of the plurality of fourth fins, a fin density of the plurality of third fins is different than a fin density of the plurality of fourth fins, or a combination thereof, the second surface being opposite the first surface.

20. The method of claim 19, wherein additive manufacturing the plurality of first fins and the plurality of second fins comprises three-dimensionally (3D) printing the plurality of first fins and the plurality of second fins on the first surface of the thermal management device, and
wherein additive manufacturing the plurality of third fins and the plurality of fourth fins comprises 3D printing the plurality of third fins and the plurality of fourth fins on the second surface of the thermal management device.
